(19) United States
(12) Patent Application Publication
(10) Pub. No.: US 2025/0271337 A1
(43) Pub. Date: Aug. 28, 2025

(54) A METHOD FOR DETERMINING WHICH OF A PLURALITY OF LIQUIDS POSE THE HIGHEST RISK OF DEPOSITING PARTICLE IMPURITIES ON A SURFACE OF A WAFER

(71) Applicant: UNISERS LTD, Zürich (CH)

(72) Inventors: Ali Özhan ALTUN, Zürich (CH); Timo Stefan SCHNEIDER, Zürich (CH)

(21) Appl. No.: 18/858,592

(22) PCT Filed: Apr. 29, 2022
(86) PCT No.: PCT/IB2022/053991

§ 371 Date: Oct. 21, 2024

(51) Int. Cl. G01N 1/28; G01N 15/00; G01N 15/06; G01N 15/08

(52) U.S. Cl. CPC G01N 1/2813; G01N 15/0606; G01N 2015/0053; G01N 2015/0687; G01N 2015/084

(57) ABSTRACT

According to the present invention there is provided various methods for determining which of a plurality of liquids pose the highest risk of depositing particle impurities on a surface of a wafer, which involve, for a plurality of different test liquids, depositing a drop of the test liquid on a surface of a wafer and then spin-drying the wafer, and repeating these steps to increase the number of particle impurities on the surface of the second wafer. There is further provided a method of determining which of a plurality of filters is best at filtering particle impurities from liquids.

### TECHNICAL DOMAIN

The present invention concerns a method for determining which of a plurality of liquids pose the highest risk of depositing particle impurities on a surface of a wafer, which involves, for a plurality of different test liquids, depositing a drop of the test liquid on a surface of a wafer and then spin-drying the wafer, and repeating these steps to increase the number of particle impurities on the surface of the wafer. There is further provided a method of determining which of a plurality of filters is best at filtering particle impurities from liquids which are to be used in a wafer processing step.

### BACKGROUND TO THE INVENTION

In the processing of wafers the surfaces of the respective wafers usually undergo numerous cleaning steps. These cleaning steps typically involve depositing liquids onto the surface of the wafer which are used to clean the surface of the wafer. However, all liquids, including those which are used to clean the surface of a wafer, contain particle impurities. When these liquids are deposited onto the surface of the wafer at least some of the particle impurities in those liquids typically remain on the surface of the wafer after the wafer has been dried. It is desirable to use liquids which leave a lower number of particle impurities on the surface of wafers. For example, it can be that two different types of liquids (e.g. two liquids of different composition) can be used in a cleaning steps to clean the surface of a wafer; when deciding which of the two liquids to use, it is desirable to use the liquid which will leave the lowest number of particle impurities on the surface of the wafer. There is no satisfactory methods in the prior art to identify which liquid, from a plurality of liquids, is likely to leave the lowest number of particle impurities on the surface of the wafer.

Additionally, exiting techniques for testing the number of particle impurities deposited on a wafer typically need to use wafers which initially have a low number of particle impurities on their surface; for example 12-inch wafers tend to have a low baseline of particle impurities. By using wafers which have a low baseline of particle impurities, any particle impurities found on the surface of the wafer after having applied the liquid to the surface of the wafer, can be considered to have come from the liquid. However, the problem with this technique is that wafers which have a low baseline of particle impurities are very expensive; the high expense of these wafers limits the number of times the technique can be carried out. Wafers with a high baseline number of particle impurities on their surface are cheaper, however existing techniques are not adapted to be performed on wafers with a high baseline number of particle impurities on their surface.

Furthermore, some of the particle impurities in a liquid will have high tendency to stick to the surface of the wafer; other particle impurities in the liquid will have a low tendency to stick to the surface of the wafer and will thus remain moveable on the surface of the wafer. In wafer processing, it is desirable to use liquids which have particle impurities that have a low tendency to stick to the surface of the wafer—this is because wafer processing typically involves more than one cleaning step and if the particle impurities deposited on the surface of the wafer are moveable there is an increased chance that those particle impurities will be removed in subsequent cleaning steps.

Additionally, some liquids which are used in wafer processing steps will undergo processing prior to use. For example, some liquids will be filtered using a filter prior to using said liquids to process a wafer; there are many different types of filters to choose from. When filtering liquids prior to their use in wafer processing, it is typically best to use the filter which will remove the most particle impurities from the liquid. There is no satisfactory methods in the prior art to identify which filter, from a plurality of filters, will remove the most particle impurities from the liquid. In other cases it can be that one needs to identify which of a plurality of filters will remove a specific type of particle impurity (e.g. particle impurities with a dimension above a predefined threshold dimension; or particle impurities having a particular composition e.g. metallic particle impurities); there is no satisfactory methods in the prior art to identify which filter, from a plurality of filters, will remove the most amount of a specific type of particle impurity from a liquid.

It is an aim of the present invention to mitigate or obviate at least some of the disadvantages associated with the prior art.

### SUMMARY OF THE INVENTION

According to the present invention, this aim is achieved by a method having, the steps recited in claim 1; and/or by methods having, the steps recited in any of the other independent claims. The dependent claims recite favourable, optional, steps which can be performed in various embodiments of the invention.

### BRIEF DESCRIPTION OF THE DRAWINGS

Embodiments of the invention, which are given by way of example only, will be described in the description, with reference to the following drawings in which in which:

FIG. 1 is a flow chart illustrating the steps in a method according to an embodiment of the present invention;

FIG. 2 shows a wafer with four discrete predefined portions of the surface of the wafer represented by respective boxes;

FIG. 3 is a flow chart illustrating the steps in a method according to an embodiment of the present invention;

FIG. 4a is a table showing the number of particle impurities measured for each wafer; FIG. 4b is a graph of the measurements shown in the table of FIG. 4a; FIG. 4c is a table showing the number of particle impurities added by the liquid samples per drop of test liquid;

FIG. 5 shows a wafer which has particle impurities on its surface; and images and Raman spectra of said particle impurities; and shows the first wafer which has particle impurities, which came from the first test liquid, on its surface; and images and Raman spectra of said particle impurities on the surface of the first test wafer.

FIG. 6 is a flow chart illustrating the steps in a method according to a further aspect of the present invention.

### DETAILED DESCRIPTION OF EMBODIMENTS OF THE INVENTION

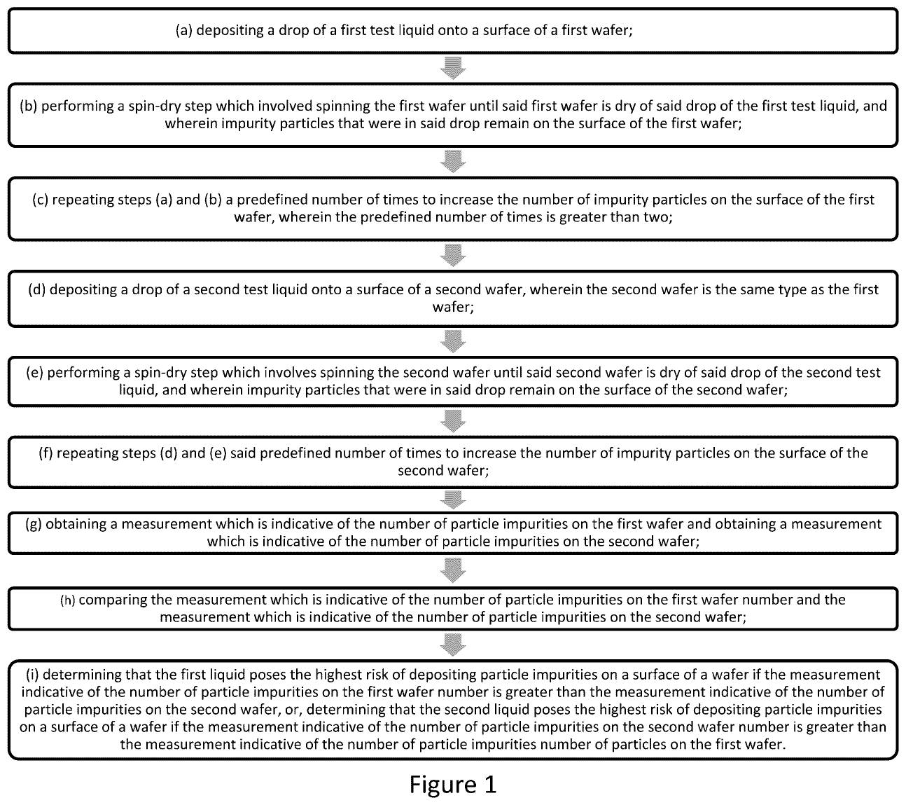

FIG. 1 is a flow chart illustrating the steps in a method according to an embodiment of the present invention, for determining which of a plurality of liquids pose the highest risk of depositing particle impurities on a surface of a wafer. The method comprise the steps of,
(a) depositing a drop of a first test liquid onto a surface of a first wafer;
(b) performing a spin-dry step which involves spinning the first wafer until said first wafer is dry of said drop of the first test liquid, and wherein particle impurities that were in said drop remain on the surface of the first wafer;
(c) repeating steps (a) and (b) a predefined number of times to increase the number of particle impurities on the surface of the first wafer, wherein the predefined number of times is greater than two;
(d) depositing a drop of a second test liquid onto a surface of a second wafer, wherein the second wafer is the same type as the first wafer;
(e) performing a spin-dry step which involves spinning the second wafer until said second wafer is dry of said drop of the second test liquid, and wherein particle impurities that were in said drop remain on the surface of the second wafer;
(f) repeating steps (d) and (e) said predefined number of times to increase the number of particle impurities on the surface of the second wafer;
(g) obtaining a measurement which is indicative of the number of particle impurities on the first wafer and obtaining a measurement which is indicative of the number of particle impurities on the second wafer;
(h) comparing the measurement which is indicative of the number of particle impurities on the first wafer number and the measurement which is indicative of the number of particle impurities on the second wafer, and
(i) determining that the first liquid poses the highest risk of depositing particle impurities on a surface of a wafer if the measurement indicative of the number of particle impurities on the first wafer number is greater than the measurement indicative of the number of particle impurities on the second wafer, or, determining that the second liquid poses the highest risk of depositing particle impurities on a surface of a wafer if the measurement indicative of the number of particle impurities on the second wafer number is greater than the measurement indicative of the number of particle impurities number of particle impurities on the first wafer.

In an embodiment the first test liquid and second test liquid are different to one another; for example, in one embodiment the first test liquid has a different composition to the composition of the second test liquid; in another embodiment the first and second test liquids may have the same composition but have undergone different processing such as, for example, the first test liquid may have been filtered by a filter and the second test liquid may be unfiltered, or, first test liquid may have been filtered by a first filter and the second test liquid may have been filtered by a second filter (the first filter may be a different type of filter to the second filter).

In this embodiment, the first test liquid has a different composition to the composition of the second test liquid; and the first test liquid is equivalent to a first liquid which can be applied to the surface of a wafer (e.g., such as a 12-inch wafer for example) in a wafer-processing-assembly to clean the surface of the wafer; the second test liquid is equivalent to a second liquid which can be applied to the surface of a wafer (e.g. such as a 12-inch wafer for example) in a wafer-processing-assembly to clean the surface of the wafer. The method illustrated in FIG. 1 can be used to determine whether it would be better to use, in wafer-processing-assembly, a liquid equivalent to the first test liquid or a liquid equivalent to the second test liquid to clean the surface of the wafer. Typically, it is preferred to use the liquid which is likely to deposit the least number of particle impurities on the surface of the wafer.

In the embodiment illustrated in FIG. 1, most preferably the first wafer is a 2-inch wafer; and the second wafer is also a 2-inch wafer. In a preferred embodiment the first wafer is an unpatterned (flat) wafer and the second wafer is also an unpatterned (flat) wafer.

Step (a) preferably comprises depositing a drop, having a volume between 10 μl-300 μl, and most preferably a volume of 50 μl, of the first test liquid onto a surface of a first wafer; and step (b) of performing a spin-dry step preferably involves spinning the first wafer, at a speed between 500 rpm-10000 rpm and most preferably at a speed of 5000 rpm. Step (c) involves repeating steps (a) and (b) a predefined number of times; most preferably the rate at which steps (a) and (b) are repeated is such that there is a time duration of between 5 seconds-60 seconds, and most preferably 10 seconds, between each iteration of step (a) i.e. most preferably there is 10 seconds between a drop of the first test liquid arriving on the surface of the first wafer and the next drop of the first test liquid arriving on the surface of the first wafer. Most preferably step (a) comprises depositing the drop close to, but offset from, the centre of the first wafer; in other words step (a) comprises depositing the drop close to the centre of the first wafer, but not directly on the precise centre of the first wafer (this is to ensure that the subsequent spin-dry step (b) can be successfully executed, because there would be no centrifugal force acting on a drop located precisely at the centre of the first wafer during the spin-dry step—this is well understood in the field).

Step (d) preferably comprises depositing, on the second wafer, a drop of a second test liquid, which has a volume which is equal to the volume of drop of the first test liquid deposited on the first wafer in step (a); in other words in this embodiment the step (d) preferably comprises depositing a drop, having a volume between 10-300 μl, and most preferably a volume of 50 μl, of the second test liquid onto a surface of a second wafer; and step (e) of performing a spin-dry step preferably involves spinning the second wafer, at a speed between 500-10000 rpm and most preferably at a speed of 5000 rpm. Step (f) involves repeating steps (d) and (e) a predefined number of times; most preferably the rate at which steps (d) and (e) are repeated is such that there is a time duration of between 5-60 seconds, and most preferably 10 seconds between each iteration of step (d) i.e. most preferably there is 10 seconds between a drop of the second test liquid arriving on the surface of the second wafer and the next drop of the second test liquid arriving on the surface of the second wafer. Most preferably step (d) comprises depositing the drop close to, but offset from, the centre of the second wafer; in other words step (d) comprises depositing the drop close to the centre of the second wafer, but not directly on the precise centre of the second wafer (this is to ensure that the subsequent spin-dry step (e) can be successfully executed, because there would be no centrifugal force acting on a drop located precisely at the centre of the second wafer during the spin-dry step—this is well understood in the field).

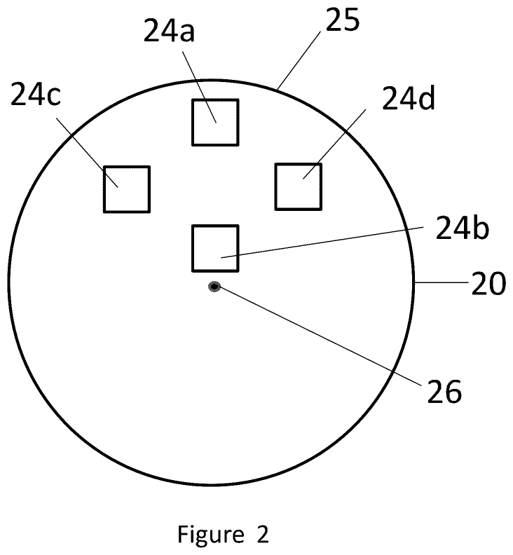

Step (g) involves obtaining a measurement which is indicative of the number of particle impurities on the first wafer and obtaining a measurement which is indicative of the number of particle impurities on the second wafer. It should be understood that any suitable measurement may be obtained. In one embodiment step (g) involves predefining portions of the surface of the wafer, and the number of particle impurities within said predefined portions are indicative of the total number of particle impurities on the wafer surface. Most preferably the predefined portions of the surface of the wafer are discrete portions of the surface of the wafer surface. For example FIG. 2 shows a wafer 20, with four discrete predefined portions 24a-24d of the surface of the wafer 20 represented by respective boxes 24a-24d. In this embodiment each of the predefined portions 24a-24d has an area of 7 mm*7 mm (preferably each of the predefined portions 24a-24d has area of at least 10 mm²; most preferably each of the predefined portions 24a-24d has area larger than 100 mm²); however it should be understood that each of the predefined portions 24a-24d may have any suitable dimension. As is shown in FIG. 2, the predefined portions 24a-24d comprise a first portion 24a which is proximate to an edge 25 of the wafer 20, a second portion 24b which is adjacent to a centre 26 of the wafer 20 but which is off-set from said centre 26; and two portions 24c, 24d which are located between said edge 25 of the wafer 20 and said centre 26 of the wafer 20. However it should be understood that the predefined portions 24a-24d may have any suitable location, but it is important that location of the predefined portions 24a-24d remain the same for each wafer.

In this embodiment, in order to obtain a measurement which is indicative of the number of particle impurities on the first wafer, the total number of particle impurities present only within these four discrete predefined portions 24a-24d of the first wafer, are determined; likewise to obtain a measurement which is indicative of the number of particle impurities on the second wafer the total number of particle impurities present only within these four discrete predefined portions 24a-24d of the second wafer, are determined. Thus, importantly the number of particle impurities present in the equivalent portions of the first and second wafers are determined. Advantageously, in this embodiment, since determining the total number of particle impurities present within only the four discrete predefined portions 24a-24d of wafer is quicker and cheaper than determining the total number of particle impurities present over the whole surface of the wafer, this embodiment allows for a more cost effective and faster method.

There are many methods for determining the number of particle impurities present on a surface of a wafer known in the art; any of these known methods can be used to determine the number of particle impurities present within the four discrete predefined portions 24a-24d of the first and second wafers. For example, WO2020/229876 discloses a technique which can be used to determine the number of particle impurities on a surface of a wafer; the techniques disclosed in WO2020/229876 can be used to determine the number of particle impurities in the four discrete predefined portions 24a-24d of the first and second wafers.

In this embodiment step (h) may comprise comparing the determined total number of particle impurities present only within these four discrete predefined portions 24a-24d of the first wafer, with the determined total number of particle impurities present only within these four discrete predefined portions 24a-24d of the second wafer; and step (i) may comprise determining that the first liquid poses the highest risk of depositing particle impurities on a surface of a wafer if said total number of particle impurities present within these four discrete predefined portions 24a-24d of the first wafer is greater than the total number of particle impurities present within these four discrete predefined portions 24a-24d of the second wafer, or determining that the second liquid poses the highest risk of depositing particle impurities on a surface of a wafer if said total number of particle impurities present within these four discrete predefined portions 24a-24d of the second wafer is greater than the total number of particle impurities present within these four discrete predefined portions 24a-24d of the first wafer.

In another embodiment step (g) of obtaining a measurement which is indicative of the number of particle impurities on the first wafer comprises measuring the total number of particle impurities which are present on the whole surface of the first wafer; and obtaining a measurement which is indicative of the number of particle impurities on the second wafer comprises measuring the total number of particle impurities which are present on the whole surface of the second wafer. There are many methods for determining the number of particle impurities present on a surface of a wafer known in the art; any of these known methods can be used to determine the number of particle impurities present on the surfaces of the first and second wafers. For example, WO2020/229876 discloses a technique which can be used to determine the number of particle impurities on a surface of a wafer; the techniques disclosed in WO2020/229876 can be used to determine the total number of particle impurities on the whole surfaces of the respective first and second wafers.

In this other embodiment step (h) may comprise comparing the determined total number of particle impurities present on the whole surface of the first wafer, with the determined total number of particle impurities present on the whole surface of the second wafer; and step (i) may comprise determining that the first liquid poses the highest risk of depositing particle impurities on a surface of a wafer if said total number of particle impurities present on the whole surface of the first wafer is greater than the total number of particle impurities present on the whole surface of the second wafer, or, determining that the second liquid poses the highest risk of depositing particle impurities on a surface of a wafer if said total number of particle impurities present on the whole surface of the second wafer is greater than the total number of particle impurities present on the whole surface of the first wafer.

In another embodiment the method further comprises the step of determining if the concentration of particle impurities is larger in a first predefined area proximate to a centre of the wafer than in a second predefined area proximate to an edge of the wafer. If the concentration of particle impurities is larger in the first predefined area proximate to a centre of the wafer than the concentration of particles impurities in the second predefined area proximate to an edge of the wafer, then this will indicate that the test liquid which was dropped onto the surface of that wafer deposited a higher proportion of particle impurities which tend to stick to the surface of the wafer than particle impurities which are moveable on the surface of the wafer. Likewise if the concentration of particle impurities is larger in the second predefined area proximate to the edge of the wafer than the concentration of particle impurities in the first predefined area proximate to the centre of the wafer, then this will indicate that the test liquid which was dropped onto the surface of that wafer deposited a higher proportion of particle impurities which are moveable on the surface of the wafer than particle impurities which stick to the surface of the wafer, since these particle impurities present at the second predefined area proximate to the edge of the wafer have moved by centrifugal force to that position on the surface of the wafer during the spin-dry step. In wafer cleaning processes it is often preferable to use liquids which deposit a lower amount of particle impurities which tend to stick to the surface of the wafer than particle impurities which are moveable on the surface of the wafer; this is because wafer cleaning processes often involve numerous cleaning steps and particle impurities which are moveable on the surface of the wafer have a higher chance of being removed in subsequent cleaning steps. It should be understood that the precise location of the first predefined area proximate to a centre of the wafer and the precise location of the second predefined area proximate to an edge of the wafer, maybe chosen at the discretion of the user. Most preferably the first predefined area proximate to a centre of the wafer will not be located precisely at the centre of the wafer, but rather will be offset from the precise centre of the wafer-because there is no centrifugal force present at the precise centre of the wafer during a spin-dry step; what is important is that the locations of the first and second predefined areas remain the same for each wafer so as to allow for an accurate comparison of the different liquids under test. Most preferably, for wafers which have a diameter of 100 mm or more, the first predefined area is located within a 20 mm distance from the edge of the wafer; and for wafer which have a diameter of less than 100 mm, the first predefined area is located within wafers which has a diameter of 100 mm or more, the first predefined area is located within 10 mm distance from the edge of the wafer. Most preferably for wafers which have a diameter of 100 mm or more, the second predefined area is located somewhere between 10 mm distance from the centre of the wafer and 20 mm distance from the edge of the wafer; and for wafer which have a diameter of less than 100 mm, the second predefined area is located somewhere between 10 mm distance from the centre of the wafer and 10 mm distance from the edge of the wafer.

For example, any of the above-mentioned method embodiments may further comprise a step of defining a first predefined area which is proximate to a centre of a wafer, and defining a second predefined are which is proximate to an edge of a wafer. Any of the above-mentioned method embodiments may further comprise the steps of, determining the number of particle impurities present in an area on the surface of the first wafer which is equivalent to the first predefined area, to obtain a first centre value; and determining the number of particle impurities present in an area on the surface of the first wafer which is equivalent to the second predefined area, to obtain a first edge value; then comparing the first centre value with the first edge value; and determining that the first test liquid deposits has a higher portion of sicky particle impurities than moveable particle impurities if the first centre value is greater than the first edge value, or, determining that the first test liquid deposits has a higher portion of moveable particle impurities than sticky particle impurities if the first edge value is greater than the first centre value.

Likewise, any of the above-mentioned method embodiments may further comprise the steps of, determining the number of particle impurities present in an area on the surface of the second wafer which is equivalent to the first predefined area, to obtain a second centre value; and determining the number of particle impurities present in an area on the surface of the second wafer which is equivalent to the second predefined area, to obtain a second edge value; then comparing the second centre value with the second edge value; and determining that the second test liquid deposits has a higher portion of sicky particle impurities than moveable particle impurities if the second centre value is greater than the second edge value, or, determining that the second test liquid deposits has a higher portion of moveable particle impurities than sticky particle impurities if the second edge value is greater than the second centre value.

In a further embodiment the method may further comprise comparing the first centre value with the second centre value, and/or comparing the first edge value with the second edge value, and/or comparing the first edge value with the second centre value, and/or comparing the first centre value with the second edge value; any one or more of these comparisons allows additional comparison of the characteristics of the particle impurities (in particular the tendency of the particle impurities to stick to a wafer surface) from the first and second liquids.

In another embodiment the method further comprises obtaining an image of a particle impurity on the surface of the first wafer; and obtaining an image of a particle impurity on the surface of the second wafer. Most preferably the method further comprises obtaining a plurality of images each image being of a respective particle impurity on the surface of the first wafer—these images depict the particle impurities which are contained in the first test sample; and obtaining a plurality of images each image being of a respective particle impurity on the surface of the second wafer—these images depict the particle impurities which are contained in the second test sample. These images are then preferably stored in a memory to form a library; so a first part of the library contains images of respective particle impurities which are contained in the first test sample and a second part of the library contains images of respective particle impurities which are contained in the second test sample. These images can be used as references to determine the likely source of a particle on a wafer (such as a 12-inch wafer): For example, if a test wafer (e.g. a 12-inch wafer) has undergone a cleaning process which involved applying a plurality of different liquids, including liquids which are equivalent to (i.e. have the same/similar composition as) the first and second test liquids, to the surface of the test wafer, and subsequently an image of a particle on the surface of a test wafer is captured, that image of the particle can be compared to the images in the library. If the comparison shows that the captured image is similar to the images contained in the first part of the library then it can be deduced that the source of that particle was the liquid which has the same/similar composition as the first test liquid, and which was applied to the surface of the test wafer during the cleaning process. If the comparison shows that the captured image is similar to the images contained in the second part of the library then it can be deduced that the source of that particle was the liquid which has the same/similar composition as the second test liquid, and which was applied to the surface of the test wafer during the cleaning process. So the library of images can be used as a reference to identify the likely sources of particle impurities on the surface of a wafer.

In an embodiment, the images depicting the particle impurities which are contained in the first test sample are retrieved from the memory and said image of the particle on the surface of a test wafer is compared to said retrieve images; if the comparison shows that said image of the particle on the surface of a test wafer is similar to the retrieved images then it can be deduced that the source of that particle was the liquid which has the same/similar composition as the first test liquid, and which was applied to the surface of the test wafer during the cleaning process. If the comparison shows that said image of the particle on the surface of a test wafer is not similar to the retrieved images, then the images depicting the particle impurities which are contained in the second test sample are retrieved from the memory and said image of the particle on the surface of a test wafer is compared to said retrieve images; if the comparison shows that said image of the particle on the surface of a test wafer is similar to the retrieved images then it can be deduced that the source of that particle was the liquid which has the same/similar composition as the second test liquid, and which was applied to the surface of the test wafer during the cleaning process.

In a further embodiment the method further comprises obtaining a Raman spectra of a particle impurity on the surface of the first wafer; and obtaining a Raman spectra of a particle impurity on the surface of the second wafer. Most preferably the method further comprises obtaining a plurality of a Raman spectra each Raman spectra being of a respective particle impurity on the surface of the first wafer—these a Raman spectra depict the Raman spectra of particle impurities which are contained in the first test sample; and obtaining a plurality of a Raman spectra each Raman spectra being of a respective particle impurity on the surface of the second wafer—these Raman spectra depict the Raman spectra of particle impurities which are contained in the second test sample. These Raman spectra are then preferably stored in a memory; so a first part of the memory contains Raman spectra of respective particle impurities which are contained in the first test sample and a second part of the memory contains Raman spectra of respective particle impurities which are contained in the second test sample. These Raman spectra can be used as references to determine the likely source of a particle on a wafer: For example, if a test wafer has undergone a cleaning process which involved applying a plurality of different liquids, including liquids which are equivalent to (i.e. have the same/similar composition as) the first and second test liquids, to the surface of the test wafer, and subsequently the Raman spectra of a particle impurity on the surface of a test wafer is obtained, that obtained Raman spectra can be compared to the Raman spectra which are stored in the memory. If the comparison shows that the obtained Raman spectra is similar to the Raman spectra contained in the first part of the memory then it can be deduced that the source of that particle was the liquid which has the same/similar composition as the first test liquid, and which was applied to the surface of the test wafer during the cleaning process. Likewise, if the comparison shows that the obtained Raman spectra is similar to the Raman spectra contained in the second part of the memory then it can be deduced that the source of that particle was the liquid which has the same/similar composition as the second test liquid, and which was applied to the surface of the test wafer during the cleaning process. So the Raman spectra stored in memory can be used as a reference to identify the likely sources of particle impurities on the surface of a wafer.

In a more preferred embodiment both the images and the Raman spectra stored in memory are used to identify the likely sources of particle impurities on the surface of a wafer (e.g. a 12-inch wafer). For example, a preferred embodiment may comprise the steps of providing a wafer (e.g. a 12-inch wafer) which has particle impurities on a surface of said wafer. In this preferred embodiment, a first liquid which is equivalent to the first test liquid (i.e. the first liquid has a composition which is the same composition, or very similar composition, to the first test liquid) was applied to the surface of said wafer, and, a second liquid which is equivalent to the second test liquid (i.e. the second liquid has a composition which is the same composition, or very similar composition, to the second test liquid) was applied to the surface of said wafer; the first and second liquids were applied to the surface of said wafer prior to the step of providing the wafer. After the wafer has been provided, obtaining an image of at least one particle on the surface of the wafer; and obtaining a Raman spectra for said at least one particle; and comparing the obtained image with one or more images of particle impurities on the surface of the first wafer and with one or more images of particle impurities on the surface of the second wafer, and comparing the obtained Raman spectra with said Raman spectra of one or more particle impurities on the surface of the first wafer and with said Raman spectra of one or more particle impurities on the surface of the second wafer (it should be understood that the one or more images of particle impurities on the surface of the first wafer and with one or more images of particle impurities on the surface of the second wafer may be stored in a memory, and the method may comprise a step of retrieving these images from said memory for comparison with said obtained image; it should be understood that the one or more Raman spectra of particle impurities on the surface of the first wafer and the one or more Raman spectra of particle impurities on the surface of the second wafer may be stored in a memory, and the method may comprise a step of retrieving these Raman spectra from memory for comparison with said obtained Raman spectra). Then, determining that the particle was deposited on the surface of the wafer by the first liquid if the obtained image and obtained Raman spectra are more similar to images and Raman spectra for the particle impurities on the surface of the first wafer than said images and Raman spectra for the particle impurities on the surface of the second wafer, or, determining that the particle was deposited on the surface of the wafer by the second liquid if the obtained image and obtained Raman spectra are more similar to said images and Raman spectra for the particle impurities on the surface of the second wafer than said images and Raman spectra for the particle impurities on the surface of the first wafer.

In order to determine if the obtained image and obtained Raman spectra, are more similar to images and Raman spectra for the particle impurities on the surface of the first wafer than said images and Raman spectra for the particle impurities on the surface of the second wafer, or, are more similar to said images and Raman spectra for the particle impurities on the surface of the second wafer than said images and Raman spectra for the particle impurities on the surface of the first wafer, the user can simply visually inspect the images and Raman spectra. Typically, the images and Raman spectra for the particle impurities on the first wafer will look very different to the images and Raman spectra for the particle impurities on the second wafer—and these differences will be very clear to the naked eye. For example, typical similarities or differences which the user can look for when comparing images, include (but are not limited to): are the images showing a single particle or an agglomeration of a plurality of particles; do the particles in each image have an organic film (organic film is detected by local increase of the background signal around particle); what shape is the particle in each image (for example are both images depicting a rod-shaped particles, or spherical-shaped particles); do the images which are being compared show similar watermark deposition of the evaporation of droplets. For example if the image for a particle impurity on the surface of the first wafer shows single, rod-shaped particle with an organic film; and the image for a particle impurity on the surface of the second wafer shows an agglomeration of a plurality of spherical-shaped particles particle with no organic films, and the obtained image depicts a single, rod-shaped particle with an organic film, then it is clear that the obtained image is more similar to the image for the particle impurity on the surface of the first wafer. In one embodiment the Raman spectra can be easily compared by overlaying the Raman spectra; for example the obtained Raman spectra is overlayed with the Raman spectra for the particle impurity on the surface of the first wafer and the obtained Raman spectra is overlayed with the Raman spectra for the particle impurity on the surface of the second wafer, and in this way the user can determine whether the obtained Raman spectra is more similar to the Raman spectra for the particle impurity on the surface of the first wafer or to the Raman spectra for the particle impurity on the surface of the second wafer. Consequently whether the obtained image and obtained Raman spectra are more similar to images and Raman spectra for the particle impurities on the surface of the first wafer than said images and Raman spectra for the particle impurities on the surface of the second wafer, or, are more similar to said images and Raman spectra for the particle impurities on the surface of the second wafer than said images and Raman spectra for the particle impurities on the surface of the first wafer, can be determined by the naked eye.

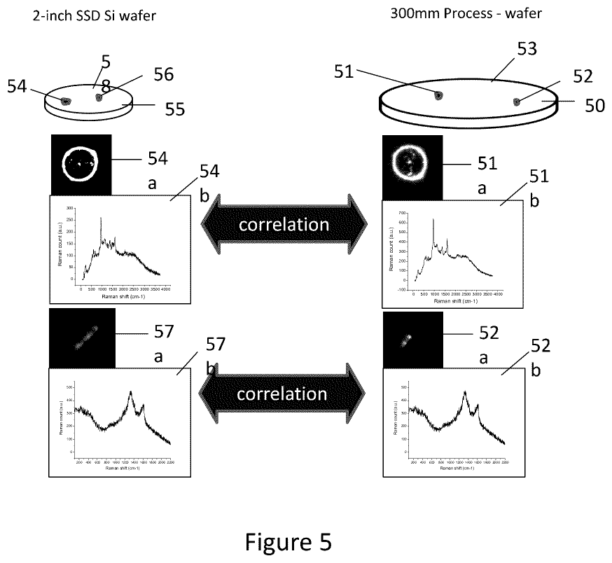

FIG. 5 shows a wafer 50 which has a first particle impurity 51 and second particle impurity 52 on a surface 53 of the wafer 50. An image of the first particle impurity 51 was obtained to provide a first image 51a and a Raman spectra of the first particle impurity was obtained to provide a first Raman spectra 51b. An image of the second particle impurity 52 was obtained to provide a second image 52a and a Raman spectra of the second particle impurity was obtained to provide a second Raman spectra 52b. In order to determine the likely source of these particle impurities the first and second images 51a, 52a and the first and second Raman spectra 52b,52b are compared to the images and the Raman spectra of impurities particles from the first and second test liquids, which stored in the memory.

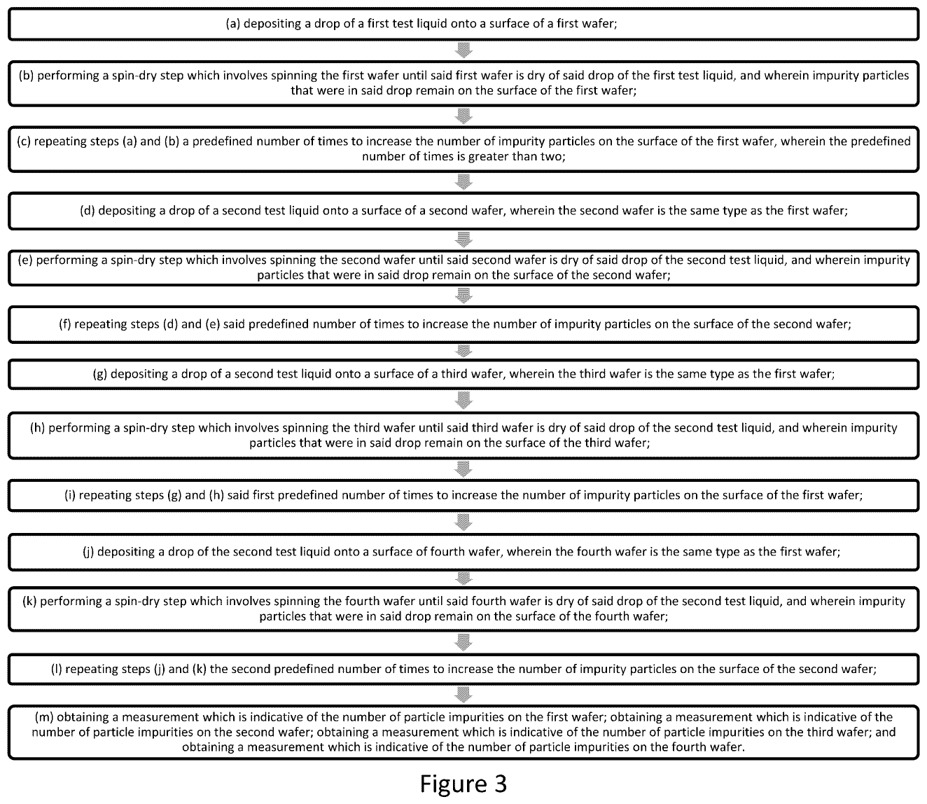

FIG. 5 also shows an first image 54a which is an image of a first particle impurity 54 which was on the surface 58 of first wafer 55 and a first Raman spectra 54b of said first particle impurity which was on the surface of first wafer 55. The first image 54a and the first Raman spectra 54b have been retrieved from a memory. FIG. 3 also shows a second image 57a which is an image of a second particle impurity 56 which was on the surface 58 of first wafer 55 and a second Raman spectra 54b of said second particle impurity which was on the surface 58 of first wafer 55. The second image 57a and the second Raman spectra 57b have also been retrieved from the memory.

By comparing the first and second images 51a, 52a and the first and second Raman spectra 52b,52b with the images 54a,57a and Raman spectra 54b,57b that were retrieve from memory, it can be seen by the naked eye that the first and second images 51a, 52a and the first and second Raman spectra 52b,52b are similar to the images 54a,57a and Raman spectra 54b,57b that were retrieve from memory. It can therefore be concluded that the source of the first particle impurity 51 and second particle impurity 52 on a surface 53 of the wafer 50 was a liquid, which had been applied to the surface 53 of the wafer 50 during a processing step, and which has a composition which is equivalent to, or similar to, the composition of the first test liquid.

FIG. 3 is a flow chart illustrating the steps in a method according to a further embodiment of the present invention, for determining which of a plurality of liquids pose the highest risk of depositing particle impurities on a surface of a wafer. The method comprises the steps of
(a) depositing a drop of a first test liquid onto a surface of a first wafer;
(b) performing a spin-dry step which involves spinning the first wafer until said first wafer is dry of said drop of the first test liquid, and wherein particle impurities that were in said drop remain on the surface of the first wafer;
(c) repeating steps (a) and (b) a first predefined number of times to increase the number of particle impurities on the surface of the first wafer, wherein the first predefined number of times is greater than two;
(d) depositing a drop of the first test liquid onto a surface of second wafer, wherein the second wafer is the same type as the first wafer;
(e) performing a spin-dry step which involves spinning the second wafer until said second wafer is dry of said drop of the first test liquid, and wherein particle impurities that were in said drop remain on the surface of the first wafer;
(f) repeating steps (d) and (e) a second predefined number of times to increase the number of particle impurities on the surface of the second wafer, wherein the second predefined number of times is greater than said first predefined number of times;
(g) depositing a drop of a second test liquid onto a surface of a third wafer, wherein the third wafer is the same type as the first wafer;
(h) performing a spin-dry step which involves spinning the third wafer until said third wafer is dry of said drop of the second test liquid, and wherein particle impurities that were in said drop remain on the surface of the third wafer;
(i) repeating steps (g) and (h) said first predefined number of times to increase the number of particle impurities on the surface of the third wafer;
(j) depositing a drop of the second test liquid onto a surface of fourth wafer, wherein the fourth wafer is the same type as the first wafer;
(k) performing a spin-dry step which involves spinning the fourth wafer until said fourth wafer is dry of said drop of the second test liquid, and wherein particle impurities that were in said drop remain on the surface of the fourth wafer;
(l) repeating steps (j) and (k) the second predefined number of times to increase the number of particle impurities on the surface of the second wafer;
(m) obtaining a measurement which is indicative of the number of particle impurities on the first wafer; obtaining a measurement which is indicative of the number of particle impurities on the second wafer; obtaining a measurement which is indicative of the number of particle impurities on the third wafer; and obtaining a measurement which is indicative of the number of particle impurities on the fourth wafer.

In an embodiment the first test liquid and second test liquid are different to one another; for example, in one embodiment the first test liquid has a different composition to the composition of the second test liquid; in another embodiment the first and second test liquids may have the same composition but have undergone different processing such as, for example, the first test liquid may have been filtered by a filter and the second test liquid may be unfiltered, or, first test liquid may have been filtered by a first filter and the second test liquid may have been filtered by a second filter.

In this embodiment, the first test liquid has a different composition to the composition of the second test liquid; and the first test liquid is equivalent to a first liquid which can be applied to the surface of a wafer (e.g. such as a 12-inch wafer) in a wafer-processing-assembly to clean the surface of the wafer; the second test liquid is equivalent to a second liquid which can be applied to the surface of a wafer (e.g. such as a 12-inch wafer) in a wafer-processing-assembly to clean the surface of the wafer. For example the processing of the wafer (e.g. such as a 12-inch wafer) in a wafer-processing-assembly may include one or more cleaning steps which involve applying a liquid to the surface of the wafer to clean the surface of the wafer; this cleaning step may be carried out one of two ways: either by applying the first liquid to the surface of the wafer, or, by applying the second liquid to the surface of the wafer. The method illustrated in FIG. 3 can be used, for example, to determine whether it would be better to use the first liquid or second liquid to clean the surface of a test wafer. Typically, it is preferred to use the liquid which is likely to deposit the least number of particle impurities on the surface of the wafer.

It should be understood that the first and second test liquids could be equivalent to any liquids whatsoever which are applied to the surface of the wafer during any stage of the processing of the wafer; the first and second test liquids are not limited to being equivalent to only liquids which are used to clean the wafer surface.

In the embodiment illustrated in FIG. 3, most preferably each of the first, second, third and fourth wafers are a respective 2-inch wafers. In a preferred embodiment each of the first, second, third and fourth wafers is an unpatterned (flat) wafer.

Step (a) preferably comprises depositing a drop, having a volume between 10 μl-300 μl, and most preferably a volume of 50 μl, of the first test liquid onto a surface of a first wafer; and step (b) of performing a spin-dry step preferably involves spinning the first wafer, at a speed between 500 rpm-10000 rpm, and most preferably at a speed of 5000 rpm. Step (c) involves repeating steps (a) and (b) a first predefined number of times. In this embodiment the step (c) involves repeating steps (a) and (b) ‘49’ times (i.e. the first predefined number of times is ‘49’) so that a total of ‘50’ drops of the first test liquid are deposited onto the surface of the first wafer (and are spin-dried).

Most preferably the rate at which steps (a) and (b) are repeated is such that there is a time duration of between 5 seconds-60 seconds, and most preferably 10 seconds, between each iteration of step (a) i.e. there is preferably 10 seconds between a drop of the first test liquid arriving on the surface of the first wafer and the next drop of the first test liquid arriving on the surface of the first wafer. Most preferably step (a) comprises depositing the drop close to, but offset from, the centre of the first wafer; in other words step (a) comprises depositing the drop close to the centre of the first wafer, but not directly on the precise centre of the first wafer (this is to ensure that the subsequent spin-dry step (b) can be successfully executed, because there would be no centrifugal force acting on a drop located precisely at the centre of the first wafer during the spin-dry step—this is well understood in the field).

Step (d) preferably comprises depositing, on the second wafer, a drop of the first test liquid, which has a volume which is equal to the volume of drop of the first test liquid deposited on the first wafer in step (a); in other words in this embodiment the step (d) preferably comprises depositing a drop, having a volume between 10 μl-300 μl, and most preferably a volume of 50 μl, of the first test liquid onto a surface of the second wafer. Step (e) of performing a spin-dry step involves spinning the second wafer, at a speed between 500 rpm-10000 rpm, and most preferably at a speed of 5000 rpm. Step (f) involves repeating steps (d) and (e) a second predefined number of times; in this embodiment the step (f) involves repeating steps (a) and (b) ‘149’ times (i.e. the second predefined number of times is ‘149’) so that a total of ‘150’ drops of the first test liquid are deposited onto the surface of the second wafer (and are spin-dried).

Most preferably the rate at which steps (d) and (e) are repeated is such that there is a time duration of between 5 seconds-60 seconds, and most preferably 10 seconds between each iteration of step (d) i.e. there is preferably 10 seconds between a drop of the first test liquid arriving on the surface of the second wafer and the next drop of the first test liquid arriving on the surface of the first wafer. Most preferably step (d) comprises depositing the drop close to, but offset from, the centre of the second wafer; in other words step (d) comprises depositing the drop close to the centre of the second wafer, but not directly on the precise centre of the second wafer.

Step (g) preferably comprises depositing, on the third wafer, a drop of the second test liquid, which has a volume which is equal to the volume of drop of the first test liquid deposited on the first wafer in step (a); in other words in this embodiment the step (g) preferably comprises depositing a drop, having a volume between 10 μl-300 μl, and most preferably a volume of 50 μl, of the second test liquid onto a surface of the third wafer. Step (h) of performing a spin-dry step involves spinning the third wafer, speed between 500 rpm-10000 rpm, and most preferably at a speed of 5000 rpm. Step (i) involves repeating steps (g) and (h) said first predefined number of times; in this embodiment said first predefined number of times is ‘49’, so step (i) involves repeating steps (g) and (h) ‘49’ more times so that a total of ‘50’ drops of the second test liquid are deposited onto the surface of the third wafer (and are spin-dried).

Most preferably the rate at which steps (g) and (h) are repeated is such that there is a time duration of between 5 seconds-60 seconds, and most preferably 10 seconds, between each iteration of step (g) i.e. there is preferably 10 seconds between a drop of the second test liquid arriving on the surface of the third wafer and the next drop of the second test liquid arriving on the surface of the third wafer. Most preferably step (g) comprises depositing the drop close to, but offset from, the centre of the third wafer; in other words step (g) comprises depositing the drop close to the centre of the third wafer, but not directly on the precise centre of the third wafer.

Step (j) preferably comprises depositing, on the fourth wafer, a drop of the second test liquid, which has a volume which is equal to the volume of drop of the first test liquid deposited on the first wafer in step (a); in other words in this embodiment the step (j) preferably comprises depositing a drop, having a volume between 10 μl-300 μl, and most preferably a volume of 50μ, of the second test liquid onto a surface of the fourth wafer. Step (k) of performing a spin-dry step involves spinning the fourth wafer, at a speed between 500 rpm-10000 rpm, and most preferably at a speed of 5000 rpm.

Step (l) involves repeating steps (j) and (k) said second predefined number of times; in this embodiment said second predefined number of times is ‘149’, so step (l) involves repeating steps (j) and (k) ‘149’ more times so that a total of ‘150’ drops of the second test liquid are deposited onto the surface of the fourth wafer (and are spin-dried).

Most preferably the rate at which steps (j) and (k) are repeated is such that there is a time duration of between 5 seconds-60 seconds, and most preferably 10 seconds, between each iteration of step (j) i.e. there is preferably 10 seconds between a drop of the second test liquid arriving on the surface of the fourth wafer and the next drop of the second test liquid arriving on the surface of the fourth wafer. Most preferably step (j) comprises depositing the drop close to, but offset from, the centre of the fourth wafer; in other words step (j) comprises depositing the drop close to the centre of the fourth wafer, but not directly on the precise centre of the fourth wafer.

At this stage there is: a first wafer which has had a total of ‘50’ drops of the first test liquid deposited on its surface and spin dried; a second wafer which has had a total of ‘150’ drops of the first test liquid deposited on its surface and spin dried; a third wafer which has had a total of ‘50’ drops of the second test liquid deposited on its surface and spin dried; and a fourth wafer which has had a total of ‘150’ drops of the second test liquid deposited on its surface and spin dried.

Next, step (m) is performed in which a measurement which is indicative of the number of particle impurities on the first wafer is obtained; a measurement which is indicative of the number of particle impurities on the second wafer is obtained; a measurement which is indicative of the number of particle impurities on the third wafer is obtained; and a measurement which is indicative of the number of particle impurities on the fourth wafer is obtained. It should be understood that these measurements could be obtained at any suitable stage in the method; for example the measurement which is indicative of the number of particle impurities on the first wafer could be obtained after step (c) prior to performing step (d); and the measurement which is indicative of the number of particle impurities on the second wafer could be obtained after step (f) prior to performing step (g); the measurement which is indicative of the number of particle impurities on the third wafer could be obtained after step (i) prior to performing step (j); and the measurement which is indicative of the number of particle impurities on the fourth wafer could be obtained after step (l). It should also be understood that any suitable measurements which are indicative of the number of particle impurities on the first wafer, indicative of the number of particle impurities on the second wafer, indicative of the number of particle impurities on the third wafer, and indicative of the number of particle impurities on the fourth wafer, may be obtained, using any suitable techniques known in the art. There are many methods for determining the number of particle impurities present on a surface of a wafer known in the art; any of these known techniques can be used to obtain said measurements. For example WO2020/229876 discloses a technique which can be used to determine the number of particle impurities on a surface of a wafer; the techniques disclosed in WO2020/229876 can be used to obtain said afore-mentioned measurement.

In the preferred embodiment step (m) involves predefining portions of the surface of the wafer, and the number of particle impurities within said predefined portions are indicative of the total number of particle impurities on that wafer surface. Most preferably the predefined portions of the surface of the wafer are discrete portions of the surface of the wafer surface. For example, FIG. 2 shows a wafer 20, with four discrete predefined portions 24a-24d of the surface of the wafer 20 represented by respective boxes 24a-24d. In this embodiment each of the predefined portions 24a-24d has an area of 7 mm*7 mm (preferably each of the predefined portions 24a-24d has area of at least 10 mm²; most preferably each of the predefined portions 24a-24d has area larger than 100 mm²); however it should be understood that each of the predefined portions 24a-24d may have any suitable dimension. As is shown in FIG. 2, the predefined portions 24a-24d comprise a first portion 24a which is proximate to an edge 25 of the wafer 20, a second portion 24b which is adjacent to a centre 26 of the wafer 20 but which is off-set from said centre 26; and two portions 24c, 24d which are located between said edge 25 of the wafer 20 and said centre 26 of the wafer 20. However it should be understood that the predefined portions 24a-24d may have any suitable location, but it is important that location of the predefined portions 24a-24d remain the same for each wafer.

In this embodiment, in order to obtain a measurement which is indicative of the number of particle impurities on the first wafer, the total number of particle impurities present only within these four discrete predefined portions 24a-24d of the first wafer, are determined; to obtain a measurement which is indicative of the number of particle impurities on the second wafer the total number of particle impurities present only within these four discrete predefined portions 24a-24d of the second wafer, are determined; to obtain a measurement which is indicative of the number of particle impurities on the third wafer the total number of particle impurities present only within these four discrete predefined portions 24a-24d of the third wafer, are determined; to obtain a measurement which is indicative of the number of particle impurities on the fourth wafer the total number of particle impurities present only within these four discrete predefined portions 24a-24d of the fourth wafer, are determined. Importantly the number of particle impurities present in the equivalent portions of the first, second, third, and fourth wafers are determined. Advantageously, determining the number of particle impurities present within the four discrete predefined portions 24a-24d of a wafer is quicker and cheaper than determining the total number of particle impurities present over the whole surface of the wafer, thereby allowing for a more cost effective and faster method.

There are many methods for determining the number of particle impurities present on a surface of a wafer known in the art; any of these known methods can be used to determine the number of particle impurities present within the four discrete predefined portions 24a-24d of the first, second, third and fourth wafers. For example, WO2020/229876 discloses a technique which can be used to determine the number of particle impurities on a surface of a wafer; the techniques disclosed in WO2020/229876 can be used to determine the number of particle impurities in the four discrete predefined portions 24a-24d of the first, second, third and fourth wafers.

In the preferred embodiment the method further comprises determining, for each of the first and second test liquids, an average number of particle impurities deposited on the surface of the wafer, per drop. The step of determining the average number of particle impurities deposited on the surface of the wafer, per drop, may comprise, for each wafer, dividing, said obtained measurement which is indicative of the number of particle impurities on the surface that wafer minus a baseline (which is a value representative of number of particles which were already present on the surface of that wafer before the test liquid was dropped on to the surface of the wafer), by the number of drops of test liquid that was deposited on that wafer, to provide an intermediate average; and then finding the average of all of the intermediate averages for that wafer.

Specifically in the afore-mentioned embodiment, the method may comprise determining an average number of particle impurities deposited on the surface of the wafer, per drop, for the first test liquid, by: subtracting a baseline (which is a number representative of number of particles which were already present on the surface of the first wafer before the test liquid was dropped on to the surface of the first wafer) from the obtained measurement which is indicative of the number of particle impurities on the first wafer to provide a first intermediate value; and dividing the first intermediate value by ‘50’ (the total number of drops of the first test liquid that were deposited on the first wafer) to obtain a first intermediate average; subtracting a baseline (which is a number representative of number of particles which were already present on the surface of the second wafer before the test liquid was dropped on to the surface of the second wafer) from the obtained measurement which is indicative of the number of particle impurities on the second wafer to provide a second intermediate value; and dividing the second intermediate value by ‘150’ (the total number of drops of the first test liquid that were deposited on the second wafer) to obtain a second intermediate average; then determining the average number of particle impurities which the first test liquid deposits on the surface of a wafer, per drop, by finding the average of the first and second intermediate averages (i.e. (‘first intermediate average’+‘second intermediate average’)/2).

Likewise the method may comprise determining an average number of particle impurities deposited on the surface of the wafer, per drop, for the second test liquid, by: subtracting a baseline (which is a number representative of number of particles which were already present on the surface of the third wafer before the test liquid was dropped on to the surface of the third wafer) from the obtained measurement which is indicative of the number of particle impurities on the third wafer to provide a third intermediate value; and dividing the third intermediate value by ‘50’ (the total number of drops of the second test liquid that were deposited on the third wafer) to obtain a third intermediate average; subtracting a baseline (which is a number representative of number of particles which were already present on the surface of the fourth wafer before the test liquid was dropped on to the surface of the fourth wafer) from the obtained measurement which is indicative of the number of particle impurities on the fourth wafer to provide a fourth intermediate value; and dividing the fourth intermediate value by ‘150’ (the total number of drops of the second test liquid that were deposited on the fourth wafer) to obtain a fourth intermediate average; then determining the average number of particle impurities which the second test liquid deposits on the surface of a wafer, per drop, by finding the average of the third and fourth intermediate averages (i.e. (‘third intermediate average’+‘fourth intermediate average’)/2). It should be understood that in the present invention the baseline value can be different for different wafers; in the present embodiment the first, second, third and fourth wafers are all of the same type, therefore in this embodiment the baseline value for each wafer was considered to be the same; however in another embodiment the baseline value could differ between wafers (e.g. if the first, second, third and fourth are of different types), in which case the appropriate baseline value is used when performing the above calculations to determine the average number of particle impurities.

Most preferably the method further comprises the step of determining that the first liquid poses a higher risk of depositing particle impurities on a surface of a wafer if the average number of particle impurities which the first test liquid deposits on the surface of a wafer, per drop, is greater than the average number of particle impurities which the second test liquid deposits on the surface of a wafer, per drop, or, determining that the second liquid poses a higher risk of depositing particle impurities on a surface of a wafer if the average number of particle impurities which the second test liquid deposits on the surface of a wafer, per drop, is greater than the average number of particle impurities which the first test liquid deposits on the surface of a wafer, per drop.

The described embodiments involve testing first and second test liquids; however it should be understood that any number of liquids can be used in the embodiments of the present invention. The embodiment shown in FIG. 3, for example, is used to determine whether a first test liquid or second test liquid pose the highest risk of depositing particle impurities on a surface of a wafer; it should be understood that the method could be performed on any number of test liquids. If, for example, in the embodiment of FIG. 3 it is desired to test a third test liquid then the method would further comprise steps of depositing a drop of the third test liquid on a fifth wafer and spin drying the fifth wafer, and repeating these steps until a total of 50 drops of the third liquid have been dropped onto the surface of the fifth wafer; and would further comprise depositing a drop of the third test liquid on a sixth wafer and spin drying the sixth wafer, and repeating these steps until a total of 250 drops of the third liquid have been dropped onto the surface of the sixth wafer. And the same steps described above for first and second test liquids would also be performed for the third test liquid, and same steps described above for the first, second, third and fourth wafers would also be performed for the fifth and sixth wafers.

Also, most preferably, in the embodiment shown in FIG. 3, the number of wafers used corresponds to the number of different sets of drops to be deposited on the wafer; for example in the embodiment shown in FIG. 3, for each test liquid, two different sets of drops of test liquid are deposited on the surface of the wafer i.e. a first set of 50 drops and a second set of 150 drops, therefore for each test liquid two wafers are used: one wafer to receive the set of 50 drops of that test liquid and a second wafer to receive to the set of 150 drops of that test liquid. It should be understood that the method of the present invention may involve any number of sets of drops; for example, in the embodiment of FIG. 3, if a third set of drops (e.g. 250 drops) are to used then the method would further comprise depositing the 250 drops of the first test liquid on a fifth wafer and spin drying the fifth wafer after each drop, and depositing the 250 drops of the second test liquid on a sixth wafer and spin drying the sixth wafer after each drop. And the same steps described above for the first, second, third and fourth wafers would also be performed for the fifth and sixth wafers.

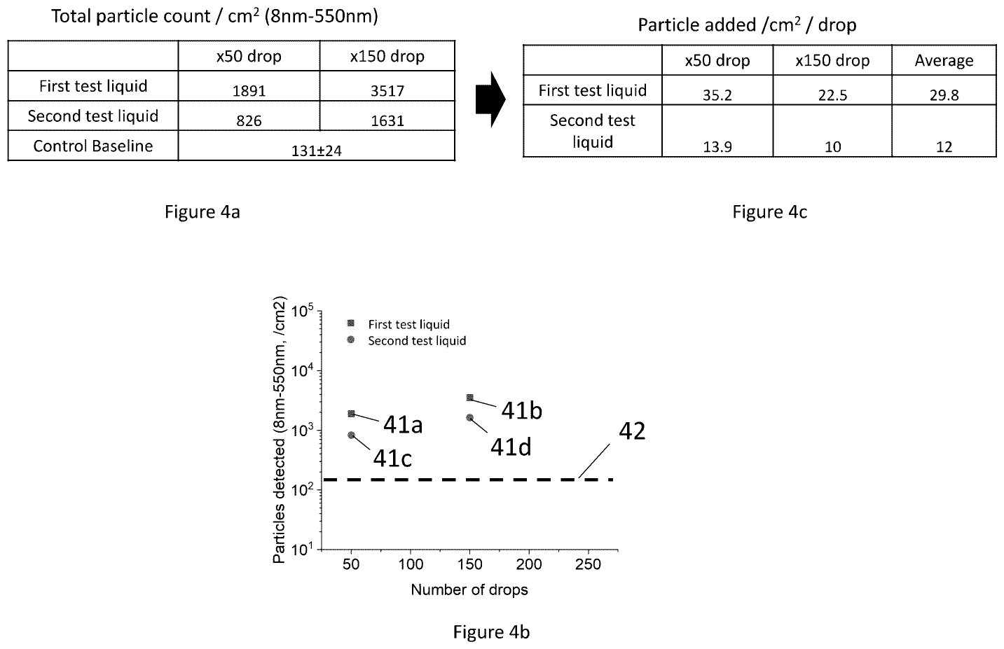

FIG. 4a is a table showing the measurements which are indicative of the number of particle impurities measured in step (m) for each wafer: the first wafer received ‘50’ drops of the first test liquid on its surface, and when step (m) was performed a measurement of ‘1891’ particle impurities was obtained; the second wafer received ‘150’ drops of the first test liquid on its surface, and when step (m) was performed a measurement of ‘3517’ particle impurities was obtained; the third wafer received ‘50’ drops of the second test liquid on its surface, and when step (m) was performed a measurement of ‘826’ particle impurities was obtained; the fourth wafer received ‘150’ drops of the second test liquid on its surface, and when step (m) was performed a measurement of ‘1631’ particle impurities was obtained.

FIG. 4b is a graph of the measurements which are indicative of the number of particle impurities measured in step (m) (along the y-axis) against the number of drops (along the x-axis)-in other words FIG. 4b is graph of the measurements shown in table in FIG. 4a: in the graph of FIG. 4b a first square 41a shown on the graph represents the number of particle impurities (i.e. ‘1891’) which were measured, in step (m), to be on the surface of the first wafer after ‘50’ drops of the first test liquid have been deposited on the first wafer and spin dried; a second square 41b shown on the graph represents the number of particle impurities (‘3517’) which were measured, in step (m), to be on the surface of the second wafer after ‘150’ drops of the first test liquid have been deposited on the second wafer and spin dried; a first circle 41c shown on the graph represents the number of particle impurities (‘826’) which were measured, in step (m), to be on the surface of the third wafer after ‘50’ drops of the second test liquid have been deposited on the third wafer and spin dried; a second circle 41d shown on the graph represents the number of particle impurities (‘1631’) which were measured, in step (m), to be on the surface of the fourth wafer after ‘150’ drops of the second test liquid have been deposited on the fourth wafer and spin dried.

The graph in FIG. 4b also shows a baseline 42; the baseline 42 may be an estimation of the number of particle impurities which were present on the surface of the first and/or second test wafers prior to the deposition of any of the first and/or second test liquids. The baseline 42 may be obtained from measurements of the number of particle impurities carried out in a calibrations step. The baseline 42 may be determined in a calibration step which involves determining the number of particle impurities per cm² on the surface of a plurality of different wafers (e.g. a plurality of 2-inch wafers, and/or a plurality of unpatterned (flat) wafers) which have not had any liquids deposited on their respective surfaces, and then determining an average for the number of particle impurities per cm²—the average number of particle impurities per cm² may define the baseline 42. For example, in one embodiment the baseline 42 is determined in a calibration step which involves, providing 10 wafers; determining the number of particle impurities on the respective surfaces of ‘10’ wafers; and then determining the average number of particle impurities per cm² for the wafers, wherein average number of particle impurities per cm² defines the baseline 42. In another embodiment the baseline 42 is determined in a calibration step which involves, providing 10 wafers, and for each 10 respective wafer determining the number of particle impurities per cm² on the surface of that respective wafer, wherein largest determined number of particle impurities per cm² defines the baseline 42. In another embodiment the baseline 42 is determined in a calibration step which involves, providing 10 wafers, and for each respective wafer determining the number of particle impurities per cm² on the surface of that respective wafer, wherein smallest determined number of particle impurities per cm² defines the baseline 42. It should be understood that the number of particle impurities per cm² on the surface of a wafer can be determined using any suitable techniques known in the art (such as the techniques disclosed in WO2020/229876).

As is evident from the graph in FIG. 4b, the method of the present invention allows for the number of particle impurities deposited by the test liquids under test to be orders of magnitude larger than the baseline number of particle impurities—this makes it easier to compare test liquids to one another, thereby allowing for more accurate comparisons of test liquids; for example prior art techniques will only result in particle impurities measurement numbers which are close to the baseline making is more difficult to compare test liquids since the differences in particle impurities measured for different test liquids could be due to variations in the baseline number of particle impurities that were on the wafers and not due to particle impurities coming from the test liquids.

FIG. 4c is a table showing the number of particle impurities per drop (i.e. the number of particle impurities added by the first and second test liquid per drop, to the surface of the first and second wafers). Each of said number of particle impurities per drop is determined by the following general formula: (‘Total number of particles detected on the wafer (shown in FIG. 4a)’−‘baseline 42’)/‘number of drops’). In this embodiment, the baseline 42 has a value of ‘131’ (as shown in FIG. 4b). Specifically the table in FIG. 4c shows: the first intermediate average ‘35.2’ (determined by (‘1891’−‘131’)/50=‘35.2’); the second intermediate average ‘22.5’ (determined by (‘3517’−‘131’)/150=‘22.5’); and the average number of particle impurities which the first test liquid deposits on the surface of a wafer, per drop ‘29.8 which is determined by (‘35.2’+‘22.5’)/2 (ie. (‘first intermediate average’+‘second intermediate average’)/2). The table in FIG. 4c also shows the third intermediate average ‘13.6’ (determined by (‘826’−‘131’)/50=‘13.9’); and the fourth intermediate average ‘10’ (determined by (‘1631’−‘131’)/150=‘10’); and the average number of particle impurities which the second test liquid deposits on the surface of a wafer, per drop ‘12’ which is determined by (‘13.9’+‘10’)/2 (ie. (‘third intermediate average’+‘fourth intermediate average’)/2). From these values in the table in FIG. 4c the user can determine that the first test liquid and/or liquids which have a composition which is the same, or similar to, the composition of the first test liquid, poses a higher risk of depositing particle impurities on the surface of a wafer than the second test liquid and/or liquids which have a composition which is the same, or similar to, the composition of the second test liquid. It should be understood that in the present invention the baseline 42 value can be different for different wafers; in the present embodiment the first, second, third and fourth wafers are all of the same type, therefore in this embodiment the baseline 42 value for each wafer was considered to be the same (‘131’); however in another embodiment the baseline 42 value could differ between wafers (e.g. if the wafers are of different types), and the appropriate baseline 42 value is used when performing the above calculations to determine the average number of particle impurities.

As mentioned, the first test liquid and second test liquid may take any suitable form. In one embodiment the first test liquid and second test liquid have the same composition, but the first test liquid has been passed through a filter before carrying out the method of the present invention whereas the second test liquid is unfiltered (i.e. has not been passed through a filter) before carrying out the method of the present invention. The method of the present invention could also be used to evaluate different types of filters to determine which filter filters the most particle impurities from a liquid, and/or to determine which filter is best as filtering out a predefined type of particle (e.g. particle which have a predefined dimension). Thus in a further aspect of the present invention there is provided a method of determining which, of a plurality of filters, is most effective in filtering particle impurities from a liquid; in this aspect of the invention a first and second liquid, having the same, or very similar compositions, is provided; and the method preferably involves passing the first liquid through a first filter and collecting the filtered liquid, wherein the filtered liquid defines the first test liquid; and passing the second liquid through a second filter and collecting the filtered liquid, wherein the filtered liquid defines the second test liquid; and then carrying out the method according to any of the above mentioned method embodiments (e.g. the method embodiment shown FIG. 1).

In one embodiment (in particular when the method embodiment of FIG. 1 is carried out) the method may comprise the step of determining that the second filter is better at filtering particle impurities from liquids than the first filter if the measurement obtained in step (g) which is indicative of the number of particle impurities on the first wafer number is greater than the measurement obtained in step (g) which is indicative of the number of particle impurities on the second wafer, or, determining that the first filter is better than filtering particle impurities from liquids than the second filter if the measurement obtained in step (g) which is indicative of the number impurity on the second wafer number is greater than the measurement obtained in step (g) which is indicative of the number of particle impurities on the first wafer.

In another embodiment (in particular when the method embodiment of FIG. 3 is carried out) the method may comprise the step of determining that the second filter is better at filtering particle impurities from liquids than the first filter if the number of particle impurities per drop determined for the first test liquid is greater than the number of particle impurities per drop determined for the second test liquid, or, determining that the first filter is better than filtering particle impurities from liquids than the second filter if the number of particle impurities per drop determined for the second test liquid is greater than the number of particle impurities per drop determined for the first test liquid.

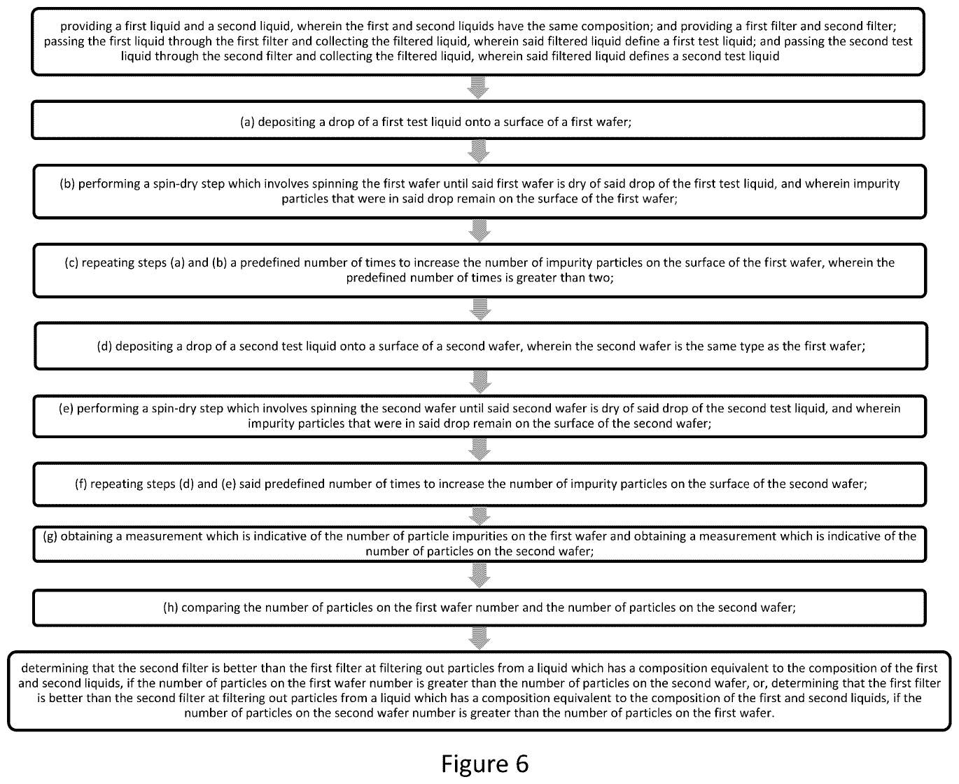

Thus, according to an embodiment of the present invention there is provided a method for determining which of a plurality of filters is best at filtering impurities out of a liquid-a flow chart illustrating the steps in and exemplary embodiment is shown in FIG. 6. This method embodiment comprises the steps of, providing a first liquid and a second liquid, wherein the first and second liquids have the same composition; and providing a first filter and second filter; passing the first liquid through the first filter and collecting the filtered liquid, wherein said filtered liquid defines a first test liquid; and passing the second test liquid through the second filter and collecting the filtered liquid, wherein said filtered liquid defines a second test liquid.

Then carrying out the steps (a)-(h) of the method embodiment shown in FIG. 1, namely:
(a) depositing a drop of a first test liquid onto a surface of a first wafer;
(b) performing a spin-dry step which involves spinning the first wafer until said first wafer is dry of said drop of the first test liquid, and wherein particle impurities that were in said drop remain on the surface of the first wafer;
(c) repeating steps (a) and (b) a predefined number of times to increase the number of particle impurities on the surface of the first wafer, wherein the predefined number of times is greater than two;
(d) depositing a drop of a second test liquid onto a surface of a second wafer, wherein the second wafer is the same type as the first wafer;
(e) performing a spin-dry step which involves spinning the second wafer until said second wafer is dry of said drop of the second test liquid, and wherein particle impurities that were in said drop remain on the surface of the second wafer;
(f) repeating steps (d) and (e) said predefined number of times to increase the number of particle impurities on the surface of the second wafer;
(g) obtaining a measurement which is indicative of the number of particle impurities on the first wafer and obtaining a measurement which is indicative of the number of particle impurities on the second wafer;
(h) comparing the measurement which is indicative of the number of particle impurities on the first wafer number and the measurement which is indicative of the number of particle impurities on the second wafer.

After step (h) has been performed, determining that the second filter is better than the first filter at filtering out particle impurities from a liquid which has a composition equivalent to the composition of the first and second liquids, if the measurement which is indicative of the number of particle impurities on the first wafer is greater than the measurement which is indicative of the number of particle impurities on the second wafer, or, determining that the first filter is better than the second filter at filtering out particle impurities from a liquid which has a composition equivalent to the composition of the first and second liquids, if the measurement which is indicative of the number of particle impurities on the second wafer is greater than the measurement which is indicative of the number of particle impurities on the first wafer.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

What is claimed is:

1. A method for determining which of a plurality of liquids pose the highest risk of depositing particle impurities on a surface of a wafer, the method comprising the steps of,
(a) depositing a drop of a first test liquid onto a surface of a first wafer;
(b) performing a spin-dry step which involves spinning the first wafer until said first wafer is dry of said drop of the first test liquid, and wherein particle impurities that were in said drop remain on the surface of the first wafer;
(c) repeating steps (a) and (b) a predefined number of times to increase the number of particle impurities on the surface of the first wafer, wherein the predefined number of times is greater than two;
(d) depositing a drop of a second test liquid onto a surface of a second wafer, wherein the second wafer is the same type as the first wafer;
(e) performing a spin-dry step which involves spinning the second wafer until said second wafer is dry of said drop of the second test liquid, and wherein particle impurities that were in said drop remain on the surface of the second wafer;
(f) repeating steps (d) and (e) said predefined number of times to increase the number of particle impurities on the surface of the second wafer;
(g) obtaining a measurement which is indicative of the number of particle impurities on the first wafer and obtaining a measurement which is indicative of the number of particle impurities on the second wafer;
(h) comparing the measurement which is indicative of the number of particle impurities on the first wafer number and the measurement which is indicative of the number of particle impurities on the second wafer; and
(i) determining that the first liquid poses the highest risk of depositing particle impurities on a surface of a wafer if the measurement indicative of the number of particle impurities on the first wafer number is greater than the measurement indicative of the number of particle impurities on the second wafer, or, determining that the second liquid poses the highest risk of depositing particle impurities on a surface of a wafer if the measurement indicative of the number of particle impurities on the second wafer number is greater than the measurement indicative of the number of particle impurities number of particle impurities on the first wafer.

2. A method according to claim 1, wherein step (c) comprises repeating steps (a) and (b) a first predefined number of times, and, wherein step (f) comprises repeating steps (d) and (e) said first predefined number of times, and wherein the method further comprises the steps of,
(c1) depositing a drop of the first test liquid onto a surface of third wafer, wherein the third wafer is the same type as the first wafer;
(c2) performing a spin-dry step which involves spinning the third wafer until said third wafer is dry of said drop of the first test liquid, and wherein particle impurities that were in said drop remain on the surface of the third wafer;
(c3) repeating steps (c1) and (c2) a second predefined number of times to increase the number of particle impurities on the surface of the third wafer, wherein the second predefined number of times is greater than said first predefined number of times;
(f1) depositing a drop of the second test liquid onto a surface of fourth wafer, wherein the fourth wafer is the same type as the second wafer;
(f2) performing a spin-dry step which involves spinning the fourth wafer until said fourth wafer is dry of said drop of the second test liquid, and wherein particle impurities that were in said drop remain on the surface of the fourth wafer;
(f3) repeating steps (f1) and (f2) the second predefined number of times to increase the number of particle impurities on the surface of the second wafer;
(m) obtaining a measurement which is indicative of the number of particle impurities on the first wafer; obtaining a measurement which is indicative of the number of particle impurities on the second wafer; obtaining a measurement which is indicative of the number of particle impurities on the third wafer; and obtaining a measurement which is indicative of the number of particle impurities on the fourth wafer.

3. A method according to claim 2 further comprising the step of determining particle impurities per drop for each of the first and second test liquids.

4. A method according to claim 3, wherein the step of determining particle impurities per drop for each of the first and second test liquids comprises,
subtracting a baseline value from the measurement which is indicative of the number of particle impurities on the first wafer to provide a first intermediate value, and dividing the first intermediate value by a total number of drops of the first test liquid that were dropped onto the first wafer, to obtain a first intermediate average;
subtracting a baseline value from the measurement which is indicative of the number of particle impurities on the second wafer to provide a second intermediate value, and dividing the second intermediate value by a total number of drops of the first test liquid that were dropped onto the second wafer, to obtain a second intermediate average;
adding the first and second intermediate averages and dividing by ‘2’, to obtain an average particle impurities per drop for the first test liquid;
subtracting a baseline value from the measurement which is indicative of the number of particle impurities on the third wafer to provide a third intermediate value, and dividing the third intermediate value by a total number of drops of the second test liquid that were dropped onto the third wafer, to obtain a third intermediate average;
subtracting a baseline value from the measurement which is indicative of the number of particle impurities on the fourth wafer to provide a fourth intermediate value, and dividing the fourth intermediate value by a total number of drops of the second test liquid that were dropped onto the fourth wafer, to obtain a fourth intermediate average;
adding the third and fourth intermediate averages and dividing by ‘2’, to obtain an average particle impurities per drop for the second test liquid.

5. A method according to claim 4 comprising the step of, determining that the first test liquid poses a higher risk of depositing particle impurities on a surface of a wafer if the average particle impurities per drop for the first test liquid is greater than the average particle impurities per drop for the second test liquid, or, determining that the second test liquid poses a higher risk of depositing particle impurities on a surface of a wafer if the average particle impurities per drop for the second test liquid is greater than the average particle impurities per drop for the first test liquid.

6. A method according to claim 1, wherein the step of obtaining a measurement which is indicative of the number of particle impurities on the first wafer comprises measuring the number of particle impurities which are present in a plurality of predefined portions of the surface of the first wafer; and the step of obtaining a measurement which is indicative of the number of particle impurities on the second wafer comprises measuring the number of particle impurities which are present in a plurality of predefined portions of the surface of the second wafer; wherein the predefined portions of the surface of the first wafer and the predefined portions of the surface of the second wafer are in equivalent locations on said respective wafers.

7. A method according to claim 6 wherein each of the predefined portions have an area of at least 10 mm².

8. A method according to claim 6 wherein the plurality of predefined portions comprise a portion which is proximate to an edge of the wafer, a portion which is adjacent to a centre of the wafer but which is off-set from said centre of the wafer; and at least one portion which is between said edge of the wafer and said centre of the wafer.

9. A method according to claim 1 wherein the step of obtaining a measurement which is indicative of the number of particle impurities on the first wafer comprises measuring the number of particle impurities which are present on the whole surface of the first wafer; and the step of obtaining a measurement which is indicative of the number of particle impurities on the second wafer comprises measuring the number of particle impurities which are present on the whole surface of the second wafer.

10. A method according to claim 1 further comprising the steps of, for at least one of the first and/or second wafers, determining if the concentration of particle impurities is larger in a first predefined area proximate to a centre of the wafer than in a second predefined area proximate to an edge of the wafer.

11. A method according to claim 1 further comprising the steps of,
obtaining an image of a particle on the surface of the first wafer;
obtaining an image of a particle on the surface of the second wafer.

12. A method according to claim 1 further comprising the steps of,
obtaining a Raman spectra for a particle on the surface of the first wafer;
obtaining a Raman spectra for a particle on the surface of the second wafer.

13. A method according to claim 1, further comprising the steps of, providing a wafer which has particle impurities on its surface;
obtaining an image of a particle impurity on the surface of said wafer; obtaining a Raman spectra for said particle impurity; and
comparing the obtained image with an image of a particle impurity from the first test liquid on the surface of the first wafer and comparing the obtained image with an image of a particle impurity from the second test liquid on the surface of the second wafer; and
comparing the obtained Raman spectra with a Raman spectra of a particle impurity on the surface of the first wafer and comparing the obtained Raman spectra with a Raman spectra of a particle impurity on the surface of the second wafer;
determining that the particle impurity was deposited on the surface of the wafer by a liquid equivalent to the first test liquid if the obtained image and obtained Raman spectra is more similar to said image and Raman spectra of the particle impurity on the surface of the first wafer than said image and Raman spectra of particle impurity on the surface of the second wafer, or, determining that the particle impurity was deposited on the surface of the wafer by a liquid equivalent to the second liquid if the obtained image and obtained Raman spectra is more similar to said image and Raman spectra of the particle impurity on the surface of the second wafer than said image and Raman spectra of the particle impurity on the surface of the first wafer.

14. A method according to claim 13 wherein said wafer which is provided is a 12-inch wafer.

15. A method for determining which of a plurality of filters are best at filtering impurities out of a liquid, the method comprise the steps of, providing a first liquid and a second liquid, wherein the first and second liquids have the same composition; and
providing a first filter and second filter;
passing the first liquid through the first filter and collecting the filtered liquid, wherein said filtered liquid define a first test liquid; and
passing the second test liquid through the second filter and collecting the filtered liquid, wherein said filtered liquid defines a second test liquid; and then carrying out the following steps,
(a) depositing a drop of a first test liquid onto a surface of a first wafer;
(b) performing a spin-dry step which involves spinning the first wafer until said first wafer is dry of said drop of the first test liquid, and wherein particle impurities that were in said drop remain on the surface of the first wafer;
(c) repeating steps (a) and (b) a predefined number of times to increase the number of particle impurities on the surface of the first wafer, wherein the predefined number of times is greater than two;
(d) depositing a drop of a second test liquid onto a surface of a second wafer, wherein the second wafer is the same type as the first wafer;
(e) performing a spin-dry step which involves spinning the second wafer until said second wafer is dry of said drop of the second test liquid, and wherein particle impurities that were in said drop remain on the surface of the second wafer;
(f) repeating steps (d) and (e) said predefined number of times to increase the number of particle impurities on the surface of the second wafer;
(g) obtaining a measurement which is indicative of the number of particle impurities on the first wafer and obtaining a measurement which is indicative of the number of particle impurities on the second wafer;
(h) comparing the measurement which is indicative of the number of particle impurities on the first wafer number and the measurement which is indicative of the number of particle impurities on the second wafer;
determining that the second filter is better than the first filter at filtering out particle impurities from a liquid which has a composition equivalent to the composition of the first and second liquids, if the measurement which is indicative of the number of particle impurities on the first wafer is greater than the measurement which is indicative of the number of particle impurities on the second wafer, or, determining that the first filter is better than the second filter at filtering out particle impurities from a liquid which has a composition equivalent to the composition of the first and second liquids, if the measurement which is indicative of the number of particle impurities on the second wafer is greater than the measurement which is indicative of the number of particle impurities on the first wafer.
